(19) United States
(12) Patent Application Publication
(10) Pub. No.: US 2025/0391585 A1
(43) Pub. Date: Dec. 25, 2025

(54) CORE WIRE AND CABLE INCLUDING THE CORE WIRE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: JIAN-GUO CAI, Kunshan (CN); JUAN ZHENG, Kunshan (CN); LU-YU CHANG, New Taipei (TW)

(21) Appl. No.: 19/247,199

(22) Filed: Jun. 24, 2025

(30) Foreign Application Priority Data
Jun. 25, 2024 (CN) 202421462238.1

(51) Int. Cl. H01B 7/08; H01B 1/02; H01B 3/44; H01B 7/00; H01B 7/02

(52) U.S. Cl. CPC H01B 7/0807; H01B 1/023; H01B 1/026; H01B 3/445; H01B 7/0009; H01B 7/0225; H01B 7/0283; H01B 7/0861

(57) ABSTRACT

A cable includes: a core wire including a pair of inner conductors arranged at intervals in a transverse direction and an inner insulating layer covering the pair of inner conductors; a shielding layer disposed outside the insulating layer; and an outer insulating layer covering the shielding layer; wherein a cross-sectional shape of the inner conductor is flat, and a cross-sectional shape of the inner insulating layer is semicircular at least on two sides in the transverse direction.

### BACKGROUND OF THE INVENTION

### Field of the Invention

The present invention relates generally to a core wire for a cable, and a cable including the core wire, and more particularly to a core wire that has good electrical performance to transmit high-frequency signals.

### Description of Related Arts

With the development and popularization of electronic technology products, cables are widely used in household appliances, instrumentation, automation equipment, data centers, servers, switches, cloud computing and 5G as a tool for signal transmission. However, the cross-sectional shape of the inner conductor in traditional cables is circular.

China Patent No. 213519296 discloses a cable comprising a pair of inner conductors, an inner insulating layer covering the inner conductors, a shielding layer covering the inner insulating layer, and an outer layer covering the shielding layer. The cross-sectional shape of the inner conductor is circular. The position of the circular conductor is easy to move when the inner insulation layer is formed, making the relative position between the inner conductor and the inner insulation layer unstable, thus affecting the high-frequency electrical characteristics of the cable.

Therefore, it is desired to provide an improved a core wire in which the transmission of high-speed signals is more stable.

### SUMMARY OF THE INVENTION

A main object of the present invention is to provide a cable with a good electrical performance to transmit high-frequency signals and a core wire used in the cable.

To achieve the above object, a cable includes: a core wire comprising a pair of inner conductors arranged at intervals in a transverse direction and an inner insulating layer covering the pair of inner conductors; a shielding layer disposed outside the insulating layer; and an outer insulating layer covering the shielding layer; wherein a cross-sectional shape of the inner conductor is flat, and a cross-sectional shape of the inner insulating layer is semicircular at least on two sides in the transverse direction.

To achieve the above object, a core wire includes: a pair of inner conductors spaced apart in a transverse direction; and an insulating layer covering the pair of inner conductors; wherein the cross-sectional shape of the inner conductor is flat, a length direction of the cross section of the inner conductor is along the transverse direction, and a cross-sectional shape of the inner insulating layer is semicircular at least on two sides in the transverse direction.

Compared to prior art, the cross-section shape of the inner conductor in the present invention is flat, which makes the electrical performance of the cable is better.

### BRIEF DESCRIPTION OF THE DRAWING

FIG. 1 is a cross-sectional view of a first embodiment of a core wire of the present invention;

FIG. 2 is a cross-sectional view of a cable of the first embodiment using the core wire of the first embodiment;

FIG. 3 is a cross-sectional view of a cable of the second embodiment using the core wire of the first embodiment;

FIG. 4 is a cross-sectional view of a cable of the third embodiment using the core wire of the first embodiment;

FIG. 5 is a cross-sectional view of a second embodiment of a core wire of the present invention;

FIG. 6 is a cross-sectional view of a cable of the first embodiment using the core wire of the second embodiment;

FIG. 7 is a cross-sectional view of a cable of the second embodiment using the core wire of the second embodiment;

FIG. 8 is a cross-sectional view of a third embodiment of a core wire of the present invention;

FIG. 9 is a cross-sectional view of a cable of the first embodiment using the core wire of the third embodiment;

FIG. 10 is a cross-sectional view of a cable of the second embodiment using the core wire of the third embodiment;

FIG. 11 is a cross-sectional view of a forth embodiment of a core wire of the present invention;

FIG. 12 is a cross-sectional view of a cable of the first embodiment using the core wire of the forth embodiment;

FIG. 13 is a cross-sectional view of a cable of the second embodiment using the core wire of the forth embodiment;

FIG. 14 is a cross-sectional view of a fifth embodiment of a core wire of the present invention;

FIG. 15 is a cross-sectional view of a cable of the first embodiment using the core wire of the fifth embodiment;

FIG. 16 is a cross-sectional view of a cable of the second embodiment using the core wire of the fifth embodiment;

FIG. 17 is a cross-sectional view of a sixth embodiment of a core wire of the present invention;

FIG. 18 is a cross-sectional view of a cable of the first embodiment using the core wire of the sixth embodiment;

FIG. 19 is a cross-sectional view of a cable of the second embodiment using the core wire of the sixth embodiment;

FIG. 20 is a cross-sectional view of a seventh embodiment of a core wire of the present invention;

FIG. 21 is a cross-sectional view of a cable of the first embodiment using the core wire of the seventh embodiment;

FIG. 22 is a cross-sectional view of a cable of the second embodiment using the core wire of the seventh embodiment;

FIG. 23 is a cross-sectional view of a eighth embodiment of a core wire of the present invention;

FIG. 24 is a cross-sectional view of a cable of the first embodiment using the core wire of the eighth embodiment; and

FIG. 25 is a cross-sectional view of a cable of the second embodiment using the core wire of the eighth embodiment;

### DETAILED DESCRIPTION OF THE PREFERRED EMBODIMENT

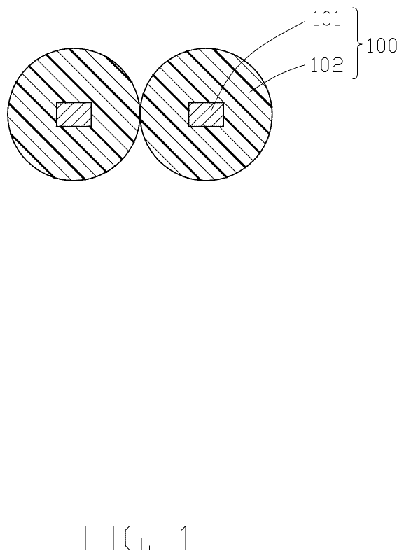

Referring to FIG. 1, the first embodiment of a core wire 100 of the present invention is shown. The core wire 100 comprises a pair of inner conductors 101, an inner insulating layer 102 covering the pair of inner conductor 11. The inner insulating layer 102 has two parts each over a corresponding one of the pair of inner conductors, and the two parts are in contact with each other. The cross-sectional shape of the inner conductor 101 is flat, and the cross-sectional shape of the inner insulating layer 102 is circular. The cross-sectional shape of each of the pair of inner conductor 101 can be rectangular, square, etc. Specifically, in the present invention, the cross-sectional shape of the conductor is rectangle with a length of 0.35 mm and a width of 0.23 mm. The inner insulating layer 102 is selected from the group consisting of solid PP (polypropylene), solid PE (polyethylene), solid FEP (Fluorinated ethylene propylene), and PTFE (Polytetrafluoroethylene).

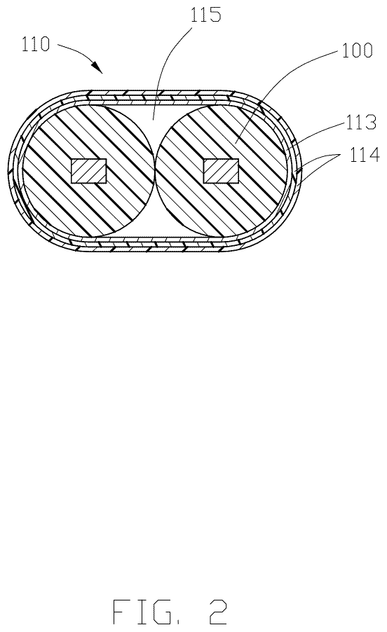

FIG. 2 shows a cross-sectional view of a cable 110 of the first embodiment using the core wire 100 of the first embodiment. The cable 110 includes a pair of core wires 100, a shielding layer 113 covering the pair of core wires 100, and an outer insulating layer 114 covering the shielding layer 113. The pair of core wires 100 are arranged at intervals in the transverse direction, and two air gaps 115 are formed at upper and lower sides between the shielding layer 113 and the pair of core wires 100. The shielding layer 113 is selected from the group consisting of AL/PET, AL/PP, AL/PET/AL, Cu/PET, Cu/PP, Cu/PET/Cu and semi-conductive tape. The material of the outer insulating layer 114 is PET tape. Specifically, in this embodiment, the outer insulating layer 114 is provided with two layers.

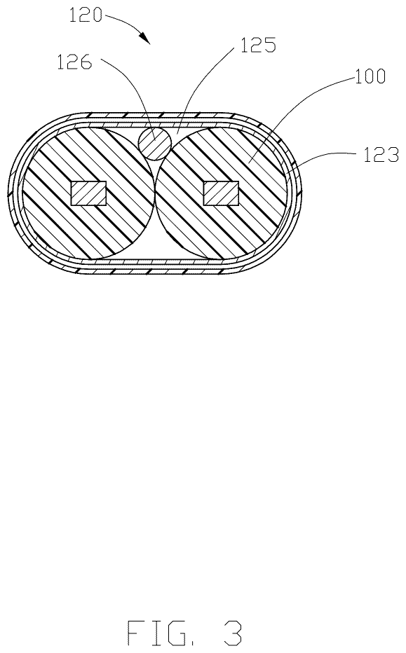

FIG. 3 shows a cross-sectional view of a cable 120 of the second embodiment using the core wire 100 of the first embodiment. Compared with the cable 110 of the first embodiment, in this embodiment, the cable 120 further comprises a ground wire 126 disposed between the pair of core wires 100 and the shielding layer 123. The ground wire 126 is disposed in an air gap 125.

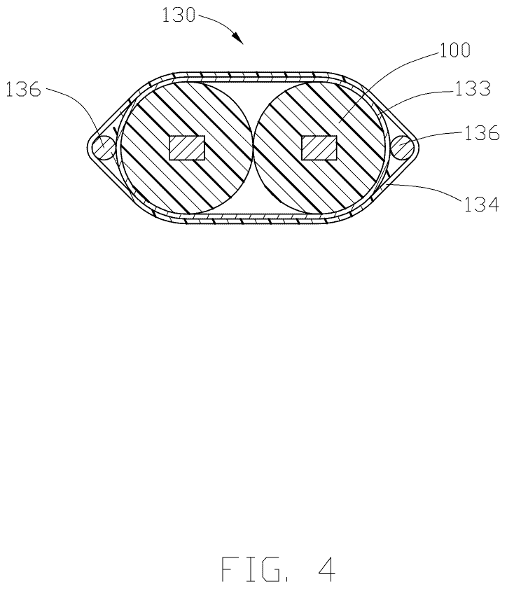

FIG. 4 shows a cross-sectional view of a cable 130 of the third embodiment using the core wire 100 of the first embodiment. Compared with the cable 110 of the first embodiment, in this embodiment, the cable 130 further comprises a pair of ground wires 136 disposed between the shielding layer 133 and the outer insulating layer 134. The pair of ground wires 136 are disposed on two sides of the shielding layer 133 in a transverse direction.

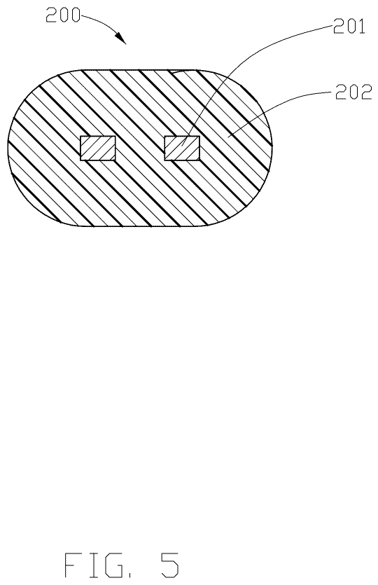

FIG. 5 shows the second embodiment of a core wire 200 of the present invention. Compared with the core wire 100 of the first embodiment, in this embodiment, the core wire 200 includes a pair of inner conductors 201, and the pair of inner conductors 201 are arranged at intervals in the transverse direction. The inner insulating layer 202 is over the pair of inner conductors 201. The cross-section of the inner insulating layer 202 has a semicircular shape on both sides in the transverse direction.

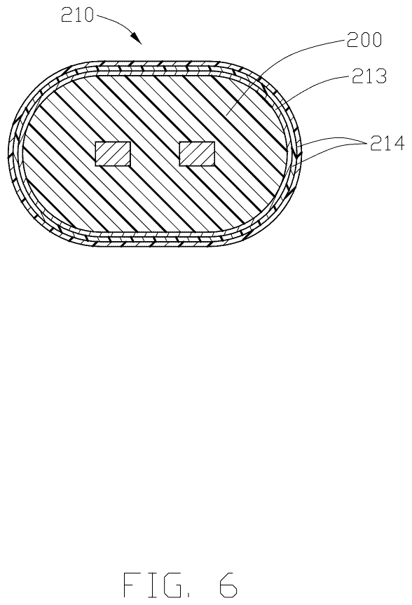

FIG. 6 shows a cross-sectional view of a cable 210 of the first embodiment using the core wire 200 of the second embodiment. The cable 210 includes the core wire 200, a shielding layer 213 covering the core wire 200, and an outer insulating layer 214 covering the shielding layer 213.

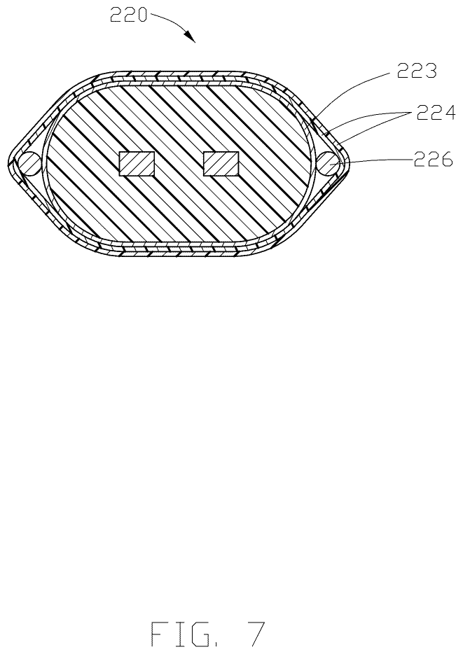

FIG. 7 shows a cross-sectional view of a cable 220 of the second embodiment using the core wire 200 of the second embodiment. Compared with the cable 210, in this embodiment, the cable 220 further includes a pair of ground wires 226 disposed between the shielding layer 223 and the outer insulating layer 224. The two ground wires 226 are disposed on two sides of the shielding layer 223 in the transverse direction.

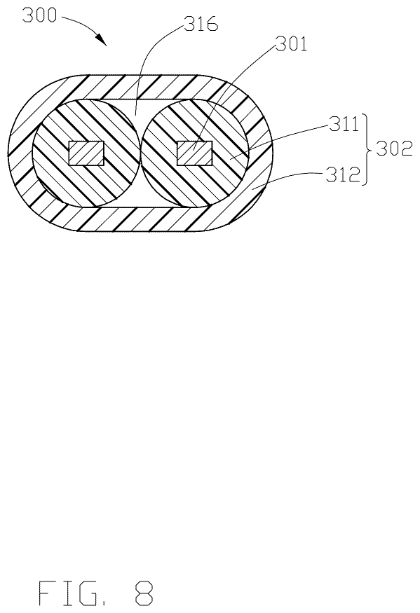

FIG. 8 shows the third embodiment of a core wire 300 of the present invention. Compared with the core wire 100 of the first embodiment, in this embodiment, the inner insulating layer 302 includes a first insulating layer 311 and a second insulating layer 312. The first insulating layer 311 has two parts each over a corresponding one of the pair of inner conductors 301, and the two parts are in contact with each other. The second insulating layer 312 covers the two parts. Two air gaps 316 are formed on the upper and lower sides between the first insulating layer 311 and the second insulating layer 312.

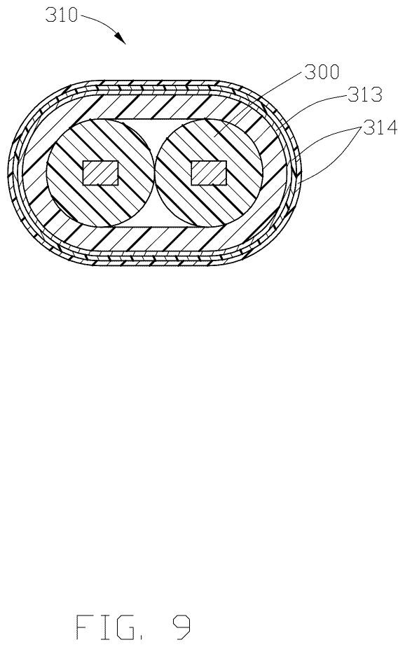

FIG. 9 shows a cross-sectional view of a cable 310 of the first embodiment using the core wire 300 of the third embodiment. In this embodiment, the cable 310 includes the core wire 300, a shielding layer 313 covering the core wire 300, and an outer insulating layer 314 covering the shielding layer 313.

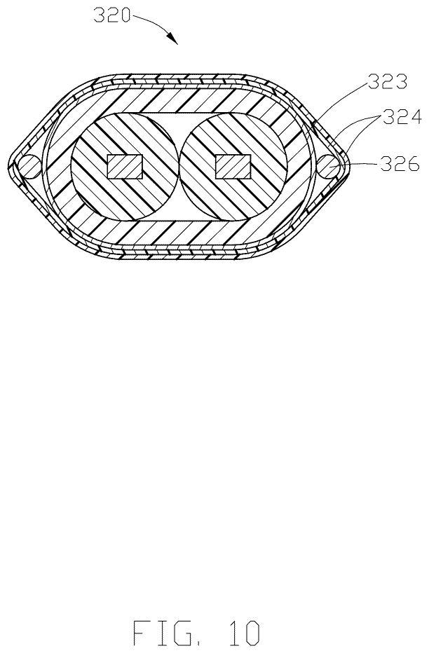

FIG. 10 shows a cross-sectional view of a cable 320 of the second embodiment using the core wire 300 of the third embodiment. Compared with the cable 310, in this embodiment, the cable 320 further includes a pair of ground wires 326 disposed between the shielding layer 323 and the outer insulating layer 324.

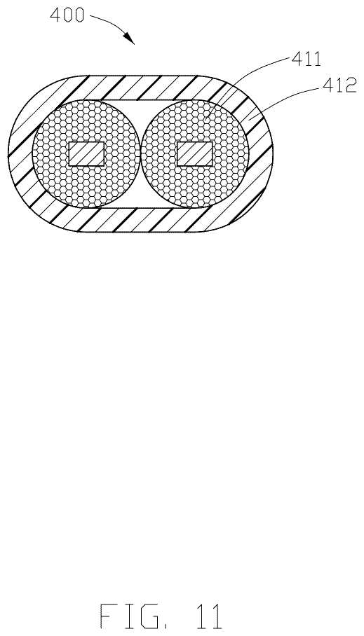

FIG. 11 shows the forth embodiment of a core wire 400 of the present invention. Compared with the core wire 300 of the third embodiment, in this embodiment, the first insulating layer 411 of the core wire 400 is made of foamed material, and the second insulating layer 412 is made of solid material. Specifically, the first insulating layer 411 is made of foamed PP, foamed PE, or foamed FEP.

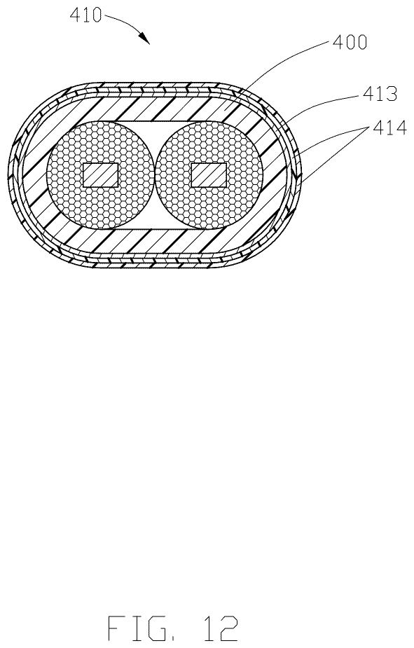

FIG. 12 shows a cross-sectional view of a cable 410 of the first embodiment using the core wire 400 of the forth embodiment. In this embodiment, the cable 410 includes the core wire 400, a shielding layer 413 covering the core wire 400, and an outer insulating layer 414 covering the shielding layer 413.

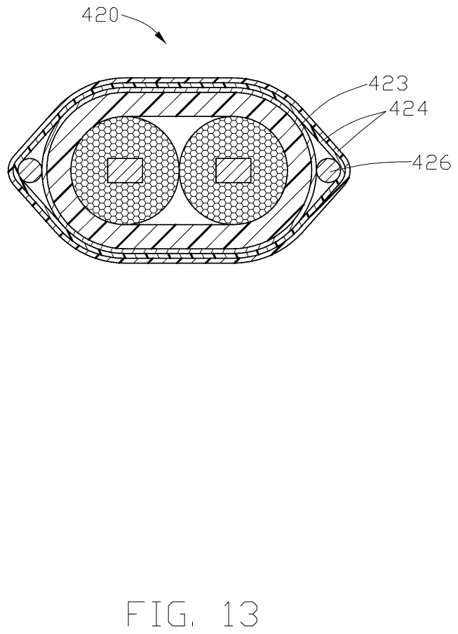

FIG. 13 shows a cross-sectional view of a cable 420 of the second embodiment using the core wire 400 of the forth embodiment. Compared with the cable 410, in this embodiment, the cable 420 further includes a pair of ground wires 426 disposed between the shielding layer 423 and the outer insulating layer 424.

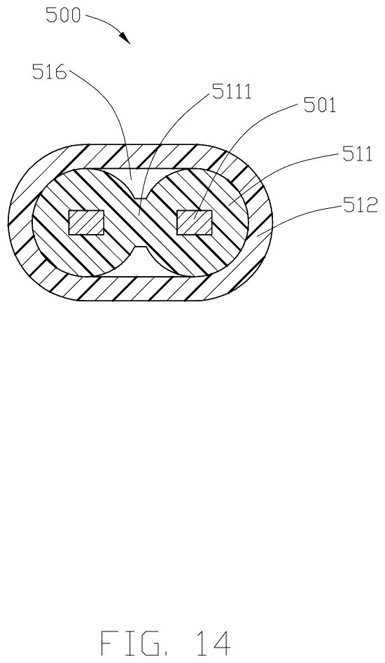

FIG. 14 shows the fifth embodiment of a core wire 500 of the present invention. Compared with the core wire 400 of the forth embodiment, in this embodiment, the first insulating layer 511 is over the pair of inner conductors 501 and includes a connecting portion 5111 located between the pair of inner conductors. The second insulating layer 512 covers the first insulating layer 511, and two air gaps 516 are formed between the second insulating layer 512 and the first insulating layer 511 at the upper and lower sides. The first insulating layer 511 and the second insulating layer 512 are both made of solid material.

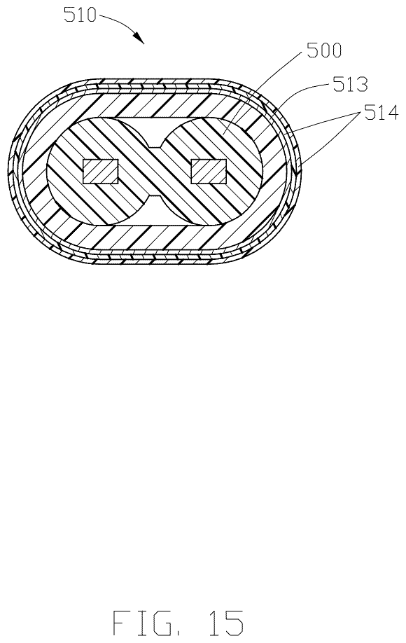

FIG. 15 shows a cross-sectional view of a cable 510 of the first embodiment using the core wire 500 of the fifth embodiment. In this embodiment, the cable 510 includes the core wire 500, a shielding layer 513 covering the core wire 500, and an outer insulating layer 514 covering the shielding layer 513.

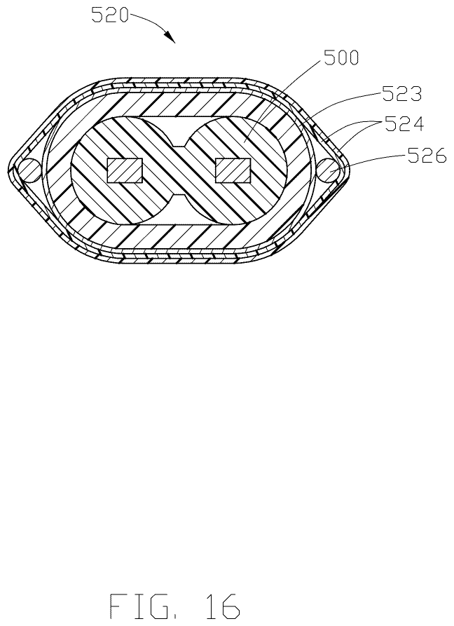

FIG. 16 shows a cross-sectional view of a cable 520 of the second embodiment using the core wire 500 of the fifth embodiment. Compared with the cable 510, in this embodiment, the cable 520 further includes a pair of ground wires 526 disposed between the shielding layer 523 and the outer insulating layer 524.

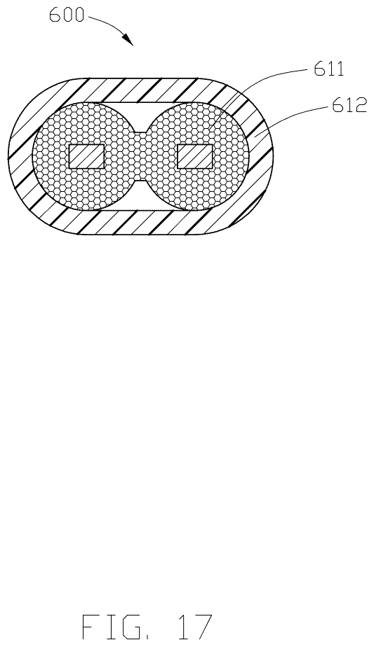

FIG. 17 shows the sixth embodiment of a core wire 600 of the present invention. Compared with the core wire 500 of the fifth embodiment, in this embodiment, the first insulating layer 611 is made of foam material, and the second insulating layer 612 is made of solid material.

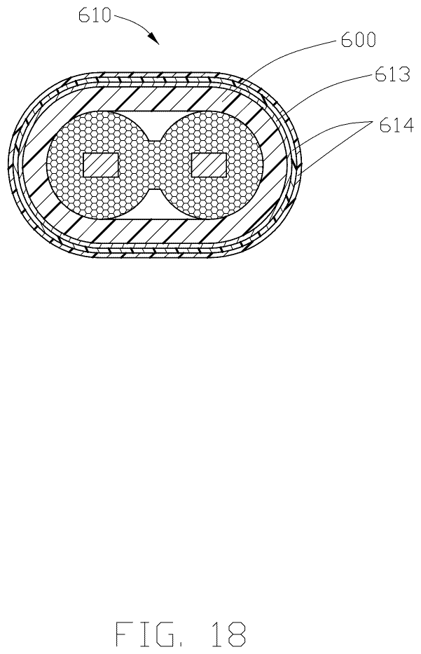

FIG. 18 shows a cross-sectional view of a cable 610 of the first embodiment using the core wire 600 of the sixth embodiment. In this embodiment, the cable 610 includes the core wire 600, a shielding layer 613 covering the core wire 600, and an outer insulating layer 614 covering the shielding layer 613.

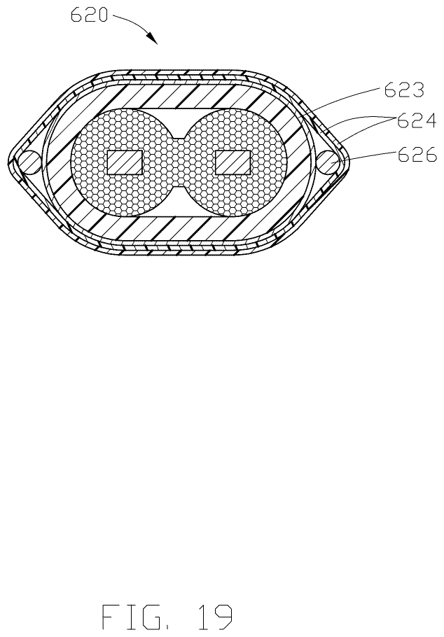

FIG. 19 shows a cross-sectional view of a cable 620 of the second embodiment using the core wire 600 of the sixth embodiment. Compared with the cable 610, in this embodiment, the cable 620 further includes a pair of ground wires 626 disposed between the shielding layer 623 and the outer insulating layer 624. The two ground wires 626 are disposed on two sides of the shielding layer 623 in the transverse direction.

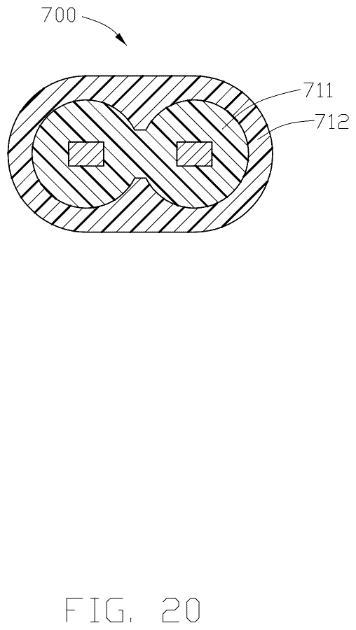

FIG. 20 shows the seventh embodiment of a core wire 700 of the present invention. Compared with the core wire 500 of the fifth embodiment, in this embodiment, there is no air gap between the first insulating layer 711 and the second insulating layer 712.

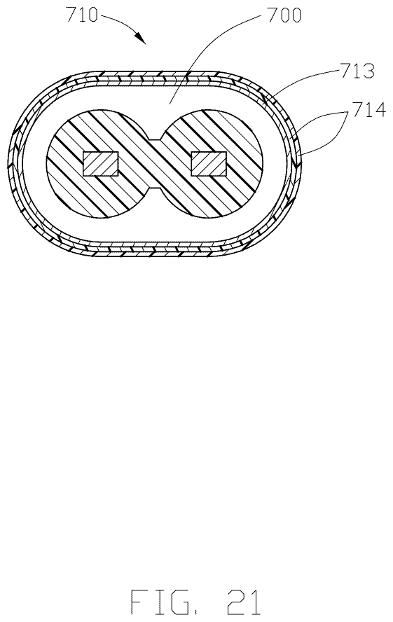

FIG. 21 shows a cross-sectional view of a cable 710 of the first embodiment using the core wire 700 of the seventh embodiment. In this embodiment, the cable 710 includes the core wire 700, a shielding layer 713 covering the core wire 700, and an outer insulating layer 714 covering the shielding layer 713.

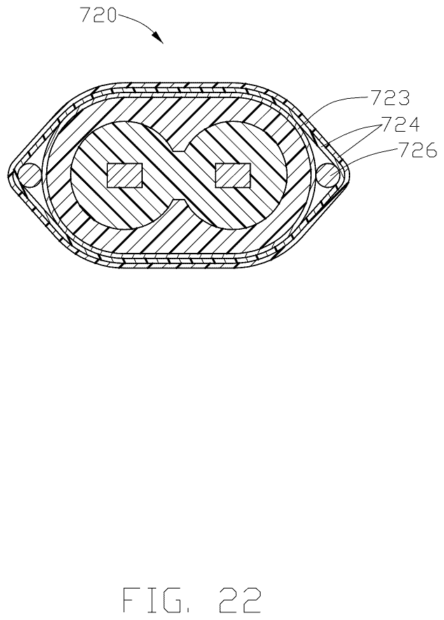

FIG. 22 shows a cross-sectional view of a cable 720 of the second embodiment using the core wire 700 of the seventh embodiment. Compared with the cable 710, in this embodiment, the cable 720 further includes a pair of ground wires 726 disposed between the shielding layer 723 and the outer insulating layer 724.

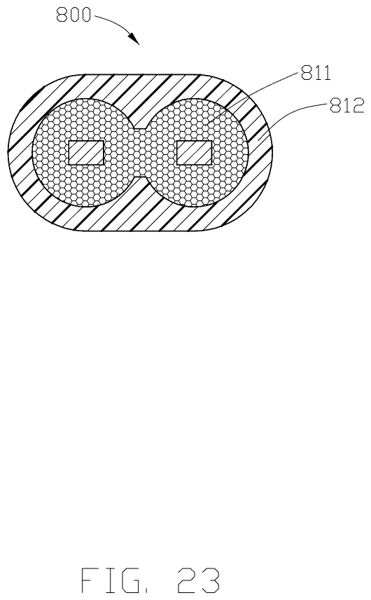

FIG. 23 shows the eighth embodiment of a core wire 800 of the present invention. Compared with the core wire 700 of the seventh embodiment, in this embodiment, the first insulating layer 811 is made of foam material, and the second insulating layer 812 is made of solid material.

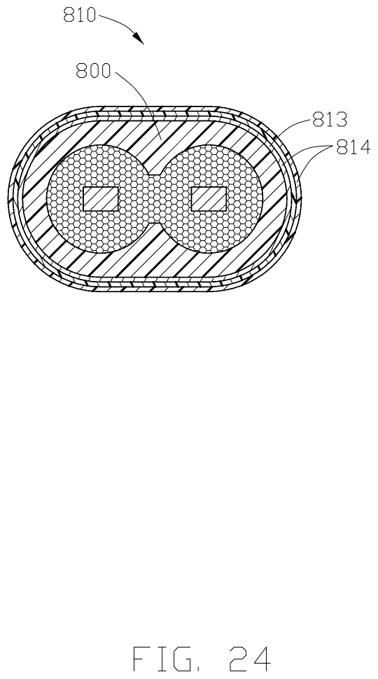

FIG. 24 shows a cross-sectional view of a cable 810 of the first embodiment using the core wire 800 of the eighth embodiment. In this embodiment, the cable 810 includes the core wire 800, a shielding layer 813 covering the core wire 800, and an outer insulating layer 814 covering the shielding layer 813.

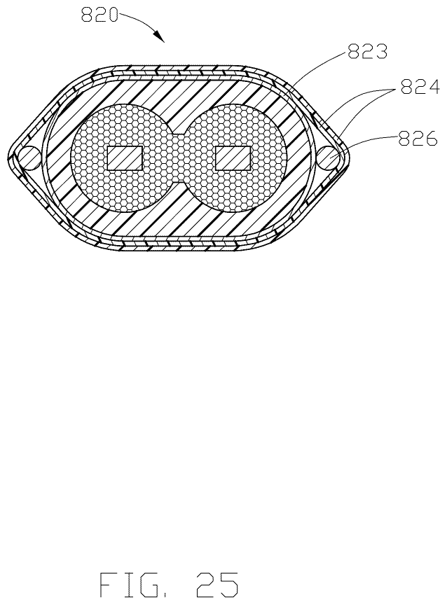

FIG. 25 shows a cross-sectional view of a cable 820 of the second embodiment using the core wire 800 of the eighth embodiment. Compared with the cable 810, in this embodiment, the cable 820 further includes a pair of ground wires 826 disposed between the shielding layer 823 and the outer insulating layer 824.

In the present invention, the cross-sectional shape of the inner conductor is flat, which can effectively avoid the high-frequency characteristics being affected by displacement, and is conducive for the subsequent soldering or cold welding of the cable to other electronic parts. Flat inner conductors have greater mechanical strength, so large diameter conductors are not required, so the cross section of the inner conductor can be reduced as much as is necessary to carry the current load. Compared to cables with round inner conductors, flat inner conductors have a better surface-to-volume ratio, which also makes them more efficient in dissipating heat. In addition, the flat inner conductor has higher flexibility and can be easily twisted, making it suitable for various application environments. The present invention provides more options and convenience for the high frequency characteristics and finished product assembly of cables.

1. A cable comprising:
a core wire comprising:
a pair of inner conductors arranged at intervals in a transverse direction; and
an inner insulating layer covering the pair of inner conductors;
a shielding layer disposed outside the insulating layer; and
an outer insulating layer covering the shielding layer; wherein
a cross-sectional shape of the inner conductor is flat, and a cross-sectional shape of the inner insulating layer is semicircular at least on two sides in the transverse direction.

2. The cable as claimed in claim 1, wherein the cross-sectional shape of each of the pair of inner conductors is rectangular.

3. The cable as claimed in claim 2, wherein the cross-sectional shape of each inner conductor is about 0.35 mm in length and about 0.23 mm in width.

4. The cable as claimed in claim 1, wherein the inner insulating layer has two parts each over a corresponding one of the pair of inner conductors, and the cross-sectional shape of each of the two parts is circular.

5. The cable as claimed in claim 4, wherein the two parts are in contact with each other.

6. The cable as claimed in claim 1, wherein the inner insulating layer is over the pair of inner conductors.

7. The cable as claimed in claim 1, wherein the inner insulating layer comprises a first insulating layer and a second insulating layer.

8. The cable as claimed in claim 7, wherein the first insulating layer has two parts each over a corresponding one of the pair of inner conductors, the two parts are in contact with each other, and the two parts are covered on the corresponding inner conductors by extrusion molding.

9. The cable as claimed in claim 7, wherein the first insulating layer is over the pair of inner conductors and includes a connection portion located between the pair of inner conductor.

10. The cable as claimed in claim 7, wherein the first insulating layer is made of foam material, and the second insulating layer is made of solid material.

11. The cable as claimed in claim 7, wherein two air gap are formed between the first insulating layer and the second insulating layer at the upper and lower sides.

12. The cable as claimed in claim 1, wherein the inner insulating layer is selected from the group consisting of foamed PP, foamed PE, foamed FEP, solid PP, solid PE, solid FEP, and solid PTFE.

13. The cable as claimed in claim 1, wherein the shielding layer is selected from the group consisting of AL/PET, AL/PP, AL/PET/AL, Cu/PET, Cu/PP, Cu/PET/Cu and semi-conductive tape.

14. A core wire comprising:
a pair of inner conductors spaced apart in a transverse direction; and
an insulating layer covering the pair of inner conductors; wherein
the cross-sectional shape of the inner conductor is flat, a length direction of the cross section of the inner conductor is along the transverse direction, and a cross-sectional shape of the inner insulating layer is semicircular at least on two sides in the transverse direction.

15. The core wire as claimed in claim 14, wherein the inner insulating layer has two parts each over a corresponding one of the pair of inner conductors, and the cross-sectional shape of each of the two parts is circular.

16. The core wire as claimed in claim 14, wherein the inner insulating layer includes a first insulating layer and a second insulating layer, the first insulating layer has two parts each over a corresponding one of the pair of inner conductors, the cross-sectional shape of each of the two parts is circular.

17. The core wire as claimed in claim 14, wherein the cross-sectional shape of each of the pair of inner conductors is rectangular.

18. The core wire as claimed in claim 17, wherein the cross-sectional shape of each inner conductor is about 0.35 mm in length and about 0.23 mm in width.
